(19) United States
(12) Patent Application Publication
(10) Pub. No.: US 2005/0111448 A1
(43) Pub. Date: May 26, 2005

(54) Generating packets

(76) Inventor: Charles E. Narad, Los Altos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/722,727

(22) Filed: Nov. 25, 2003

(51) Int. Cl. H04L 12/56

(52) U.S. Cl. 370/389; 370/469

(57) ABSTRACT

In general, in one aspect, the disclosure describes a method of generating, at a first component, a packet having a header and payload that includes data originating within the first component. The method also includes transmitting the packet to a second component further along a receive path monotonically ascending layers of a protocol stack.

### REFERENCE TO RELATED APPLICATIONS

This application relates to attorney docket number P17968 entitled “DIRECT MEMORY ACCESS (DMA) TRANSFER OF NETWORK INTERFACE STATISTICS”, filed on the same day as the present application and naming the same inventor.

### BACKGROUND

Networks enable computers and other devices to communicate. For example, networks can carry data representing video, audio, e-mail, and so forth. Due to its complexity, network communication is typically divided into different layers that conceptually group different communication operations. For example the “physical layer” handles details of handling signal transmission over a physical medium such as a wire or optic cable, while the “network layer” handles the more abstract problem of how to trace a path across intermediate nodes that connect the sender and receiver. Together, these and other layers form a “protocol stack”.

To illustrate protocol stack operation, FIG. 1A depicts the flow of some data, “a”, down the layers of a sender, across a network, and up the layers of a receiver. The path down through the sender's protocol stack is known as the “transmit path”. Likewise, the path up the receiver's protocol stack is known as the “receive path”.

In greater detail, as shown, the network layer of the sender receives some data, “a”, to transmit to the receiver. The network layer, among other operations, stores the data, “a”, within a network packet. By analogy, a packet is much like an envelope you drop in a mailbox. A packet typically includes “payload” and a “header”. The packet's “payload” is analogous to the letter inside the envelope. The packet's “header” is much like the information written on the envelope itself. The header can include information to help network devices handle the packet appropriately. For example, the header of a network packet can include an address that identifies the packet's destination. The address enables intermediate devices between the sender and receiver to forward the packet further toward its destination.

The network layer sends the network packet down the transmit path for handling by the data link layer. Among other operations, the data link layer can group the bits of a network packet within another kind of a packet known as a frame. This operation, known as “encapsulation” is much like stuffing one envelope within another. The frame header often includes a “checksum” derived from the frame packet contents that enables a receiver to verify error-free transmission of the frame packet.

As shown, the data link layer passes the frame packet further down the transmit path to the physical layer. The physical layer handles the details of transmitting bits over a physical medium. For example, the sender's physical layer may handle conversion of the series of digital bits (e.g., “1”-s and “0”-s) of a frame packet into a series of corresponding voltages or optic wavelengths.

As shown, after traveling across the network (shown as a cloud), data signals representing the transmitted frame packet eventually reach the receiver. The receiver reverses the operations performed by the sender's layers. For example, the receiver's physical layer converts the incoming signals into bits, the data link layer identifies the start and end of the frame, and the network layer de-encapsulates the data, “a”, carried within the network packet and passes this data further upstream in the receive path.

FIG. 1A describes the abstract layers of a network protocol stack. In practice, the different layer operations are handled by different hardware and/or software components local to a node. For example, FIG. 1B depicts a component known as a PHY that often handles physical layer duties while a component known as a framer often performs data link layer operations. Often a single PHY component and/or a single framer component resides in both the transmit and receive paths descending and ascending a protocol stack of a node, respectively. A given node may include many different PHYs and framers to provide connections to many different metworks.

For simplicity, FIGS. 1A and 1B only depicted a few of the layers that typically form a protocol stack. For example, the data, “a”, shown in FIG. 1A may itself be a packet generated by a transport layer atop the network layer. Operation of these other layers may also be provided by corresponding components. For example, the transport layer may be handled by a component known as a Transmission Control Protocol (TCP) Offload Engine (TOE). Additionally, FIGS. 1A and 1B depict layers common to the Open Source Institute (OSI) protocol stack and the TCP/IP protocol stack. Other protocol stacks (e.g., the Asynchronous Transfer Mode (ATM) protocol stack) feature different stack layers.

### BRIEF DESCRIPTION OF THE DRAWINGS

FIGS. 1A, 1B, 2, 3, 4A, 4B, and 7 are flow diagrams.

FIGS. 5 and 8 are schematic diagrams.

FIGS. 6 and 9 are flow-charts.

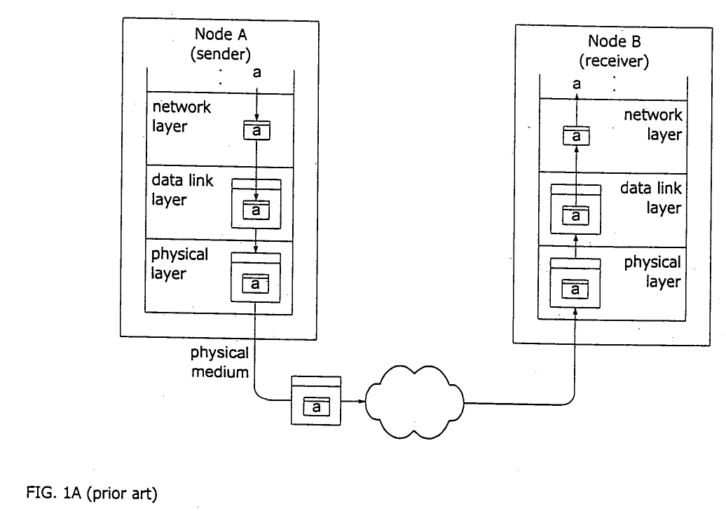

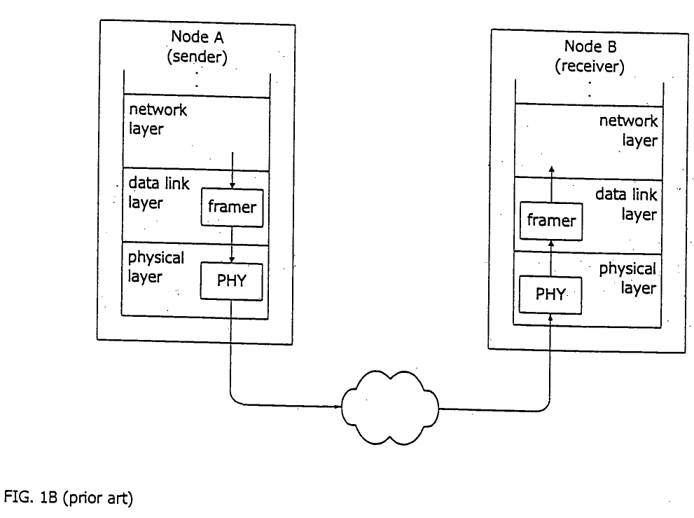

### DETAILED DESCRIPTION

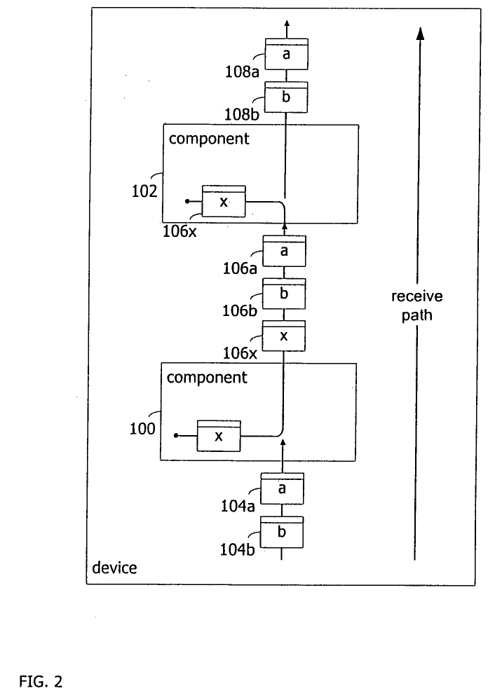

Network components, such as a PHY or framer, act as conduits for streams of in-coming (receive) and out-going (transmit) packets. In addition to handling packets streaming through, these components can also track other information. For example, framers often maintain statistics gauging framer operation such as the number of packets or bytes sent or received. Similarly, a PHY often monitors various statuses such as whether a link to a remote device is up or down. FIGS. 2-9 illustrate techniques that enable components in a packet receive or transmit path to communicate with subsequent components in the path by independently generating packets including information of interest. For example, a PHY can construct and send a packet identifying link status to a component further along in the receive path. Similarly, a framer can construct and send a packet identifying operational statistics. While conforming to the same protocol defined format as other packets traveling along the path, these generated packets can be constructed such that “upstream” components can cull them from the stream of “real” packets traveling along the path. These techniques can, potentially, conserve resources of components receiving the packets. For example, instead of a continually polling a preceding path component for information, the component can simply monitor the incoming stream of packets. Additionally, the techniques can reduce the need for an independent communication channel (e.g., a dedicated bus or a discrete signal) to carry non-packet data between the components.

FIG. 2 illustrates an example of a component 100 in a packet receive path. As shown, the component 100 passes packets 106 to other components in the receive path. The packets 106 may be the same as packets 104a, 104b received by the component 100. Alternately, the packets 106 may be de-encapsulated from within packets 104a, 104b or assembled from packet 104 data received by the component. For example, the component 100 may output an Internet Protocol (IP) packet assembled from the payload of different Asynchronous Transfer Mode (ATM) packets (“cells”).

As shown, the component 100 also independently generates packets (e.g., 106x) and injects them into the packet stream monotonically ascending the receive path. The generated packet's 106x contents include information being communicated (e.g., PHY status or framer statistics). As shown, a component 102 further along the receive path pulls the generated packet 106x from the stream and can access the packet's 106x contents. The component 102 can stop the generated packet 106x from traveling further up the receive path.

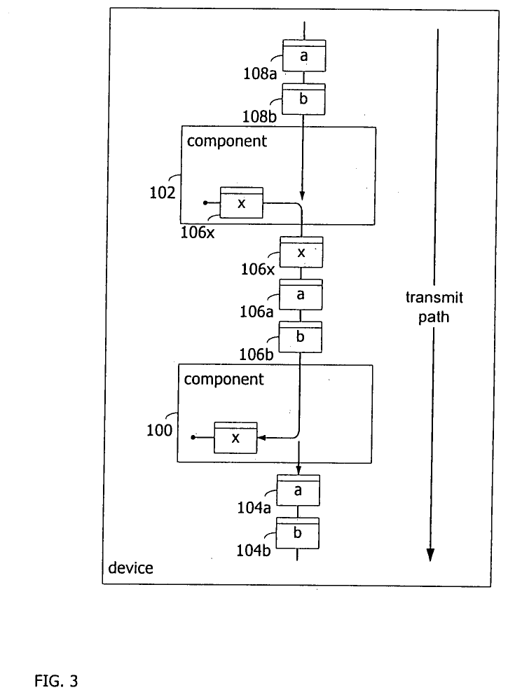

As shown in FIG. 3, a similar technique can be used to communicate to components further along the transmit path. For example, as shown, a component 102 generates a packet 106x and injects the generated packet 106x into a stream of packets traveling down the transmit path. Component 100 can remove the generated packet 106x from the out-bound packet stream, extract its contents, and stop the generated packet 106x from traveling further down the transmit path.

Both FIG. 2 and FIG. 3 depict the component generating packets being adjacent to the component intercepting the generated packets. It is also possible that the generated packet is sent to or received from a component that is further up the receive path or further up the transmit path, respectively, in which case any intervening components will pass the generated packets through in the same manner that they handle other “real” packets traversing those components.

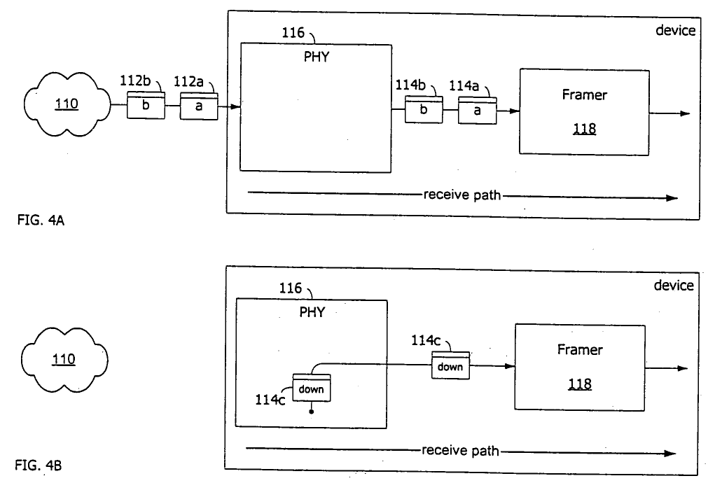

The approaches illustrated in FIGS. 2 and 3 may be implemented by a wide variety of components. For example, FIG. 4A depicts an example of a PHY 116 implementing techniques described above. As shown, the PHY 116 receives data signals corresponding to frame packets 112a, 112b and converts these data signals into bits for processing by components further along in the receive path such as framer 118.

In addition to sending packets 114a, 114b upstream, the PHY 116 also generates packets identifying different PHY 116 status information. This PHY status data can identify a variety of states and/or events. For example, a PHY (e.g., an Ethernet PHY) can monitor the status (e.g., LINK_UP or LINK_DOWN) of a negotiated link to a partner PHY at the other end of a connecting physical medium. Other PHY status information can include detection of clock drift, on-going establishment of a new link, results of a link speed negotiation and so forth.

In the example shown in FIG. 4B, after detecting that a link had gone down, the PHY 116 generates a frame packet 114c (e.g., an Ethernet frame) identifying the LINK_DOWN status and transmits the frame 114c further along the receive path. A component (e.g., framer 118, device driver software, or a host processor (not shown)) receiving the generated packet 114c can examine the generated packet's 114c contents and respond accordingly.

To enable component(s) to distinguish the generated packet 114c from other packets 114b, 114a traveling up the receive path, the PHY 116 can set header fields of the packet to certain values. For example, the PHY can set the source and destination addresses of the frame 114c to the address of the receiving device or some other flagging address. A wide variety of other packet characteristics can be manipulated to flag the generated frame 114c.

Again, this signaling mechanism can streamline communication between the PHY 116 and other receive path components. For example, transmitting status information within the packet stream may reduce the need for a separate bus that enables components to poll the PHY 116 or receive PHY generated interrupt signals.

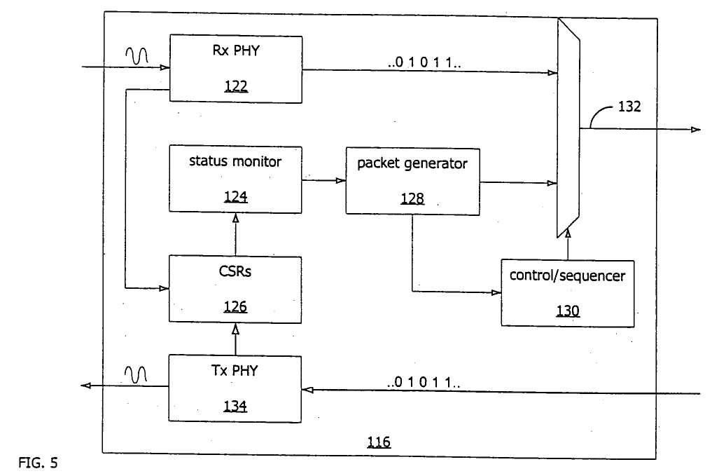

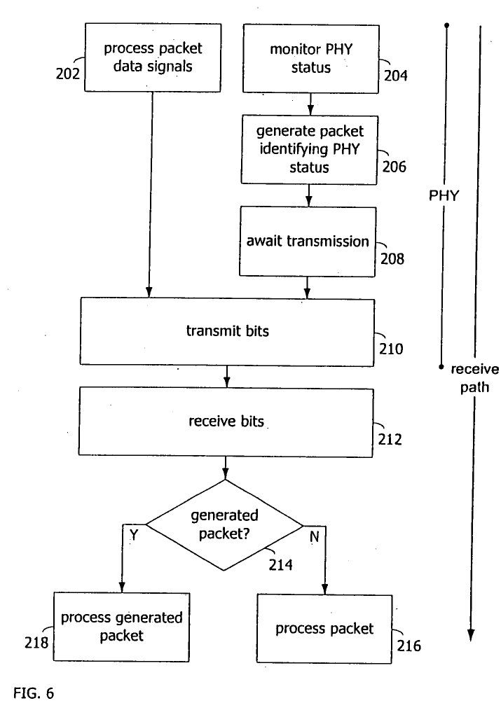

FIG. 5 depicts a sample PHY 116 architecture in greater detail. As shown, the PHY 116 includes Tx (Transmit) PHY circuitry 134 that converts bits into data signals (e.g., analog wire, wireless, or optic data signals) for transmission over a physical medium. The Tx circuitry 134 may also perform serialization, data encoding, data scrambling, encoding a clock within the data, generation of a checksum or Cyclic Redundancy Code (CRC) for data integrity verification, addition of framing bits and other data modifications, and driving the signal medium with the signals representing the converted data. The PHY 116 also includes Rx (receive) PHY circuitry 122 that, conversely, converts received data signals into digital bits. The Rx circuitry 122 may also perform operations for removal of physical framing bits, data decoding, removal and verification of data integrity bits such as a CRC or checksum, clock extraction, deserialization and other modifications. The PHY 116 outputs these bits to components further along the receive path via an output interface 132 such as a Media Independent Interface (e.g., Gigabit Media Independent Interface (GMII), 10-Gigabit Attachment Unit Interface (XAUI), Reduced Media Independent Interface (RMII), Serial Media Independent Interface (SMII), and so forth).

The PHY 116 shown also includes circuitry to monitor 124 PHY 116 status. The status may be monitored by detecting changes to Control and Status Register 126 bits set by the Rx 122 and Tx 134 circuitry identifying different PHY 116 states. Alternately, the monitoring 124 circuitry may receive status signals directly from the Rx 122 and/or Tx 134 PHY. Upon detecting a status of interest, the status monitor 124 circuitry can initiate generation and transmission of a packet identifying the status(es). The status(es) to report may be set by a configuration register (not shown). The PHY 116 may be capable of generating different types of packets for signaling different events or may send a single packet type for all events, where the packet type may include different payload contents and/or different packet header information.

When invoked, the packet generator 128 constructs a packet. For example, the packet generator 128 can retrieve a “template” packet or packet header from PHY memory (not shown) or from PHY Control and Status Registers 126. The packet generator 128 can set data within the generated packet's payload or header to indicate the status(es) of interest. The packet may also include other information such as a sequence number or a timestamp indicating the approximate time at which the packet was generated. The template may be constructed by PHY circuitry or configured or downloaded by another entity (e.g., a device driver) during PHY 116 initialization.

As shown, the PHY 116 also includes control and sequence circuitry 130 to determine when to transmit a generated packet. That is, instead of interrupting on-going transmission, the PHY 116 may wait for a period of transmission silence (e.g., a period conforming to the IEEE 802.3 Inter-Packet Gap) before sending the generated packet. An upstream component such as a framer may be designed or configured to accept packets during such periods.

In the case of a link going down, there are no new valid packets being received, so the PHY 116 can send a link down packet at any valid time. An upstream component (e.g., a framer) will have been enabled to receive packets at this time, since the link was previously up. In the case of a link going up, however, the framer 118 may need to be designed or configured to receive packets even when a link is down.

The PHY 116 can be configured in a variety of ways. For example, the PHY 116 may include configuration registers. For example, one bit of a configuration register may determine whether to generate a packet when a link goes down. Alternately, the PHY 116 may include circuitry to intercept packets traveling down the transmit path that include configuration settings (e.g., status(es) and events of interest, time(s) to generate packets, and so forth) intended for the PHY 116 to intercept and interpret.

FIG. 6 is a flow diagram illustrating sample PHY operations. As shown, the PHY recieves and processes 202 data signals received over a physical medium that represent a frame packet. The PHY forwards 210 the bits of the frame packet further along the receive path. Concurrently, the PHY circuitry monitors 204 status(es) of interest. The PHY can also generate 206 a packet including data indicating the status(es), for example, after detecting a state change, reaching a threshold, in response to a request, or at some programmed interval. The PHY transmits 210 the generated packet to the upstream device at a determined 208 time.

As, shown, a component further along the receive path may distinguish 214 the generated packets 218 from other packets 216 received 212. For example, the component may examine the packet header for values flagging the generated packet.

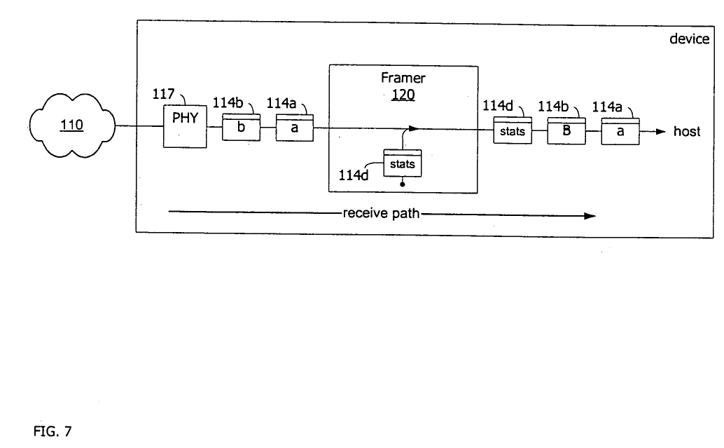

Techniques described above may be implemented in other components. For example, FIG. 7 illustrates operation of a framer 120 that processes packets 114a, 114b received from a component (e.g., PHY 117) earlier in the receive path. Such frame processing can include verifying a checksum, detecting frame boundaries, bit/character unstuffing, frame filtering, and other data link layer operations. The framer 120 may conform to one or more of a variety of data link layer protocols. For instance, the framer 120 may be an Ethernet media access controller (MAC), a High-Level Data Link Control (HDLC) framer, or a Synchronous Optical NETwork (SONET) framer.

In addition to traditional framer 120 operations, the framer 120 can also generate and inject a packet 114d into the stream 114 of packets traveling along the receive path. In the example shown, the packet 114d generated by the framer 120 indicates the value(s) of one or more network statistics. For example, an Ethernet MAC often maintains a set of counters that gather statistics about traffic traveling through the MAC. As an example, a standard called RMON (Internet Engineering Task Force, Request for Comments #3577, Introduction to Remote Monitoring (RMON) Family of MIB Modules, Waldbusser, et al., August 2003) specifies a set of more than 70-counters for Ethernet Layer 2 packet status such as bytes sent and received, number of packets sent and received, “buckets” of packet size ranges, various network congestion and error conditions, and so forth. Generating a packet that includes statistics of interest can conserve resources of a component further along the path (e.g., a central processing unit (CPU), network processor (NP), or TCP/IP Offload Engine (TOE)). For example, a host processor need not poll the framer 120 or perform repeated framer 120 register reads.

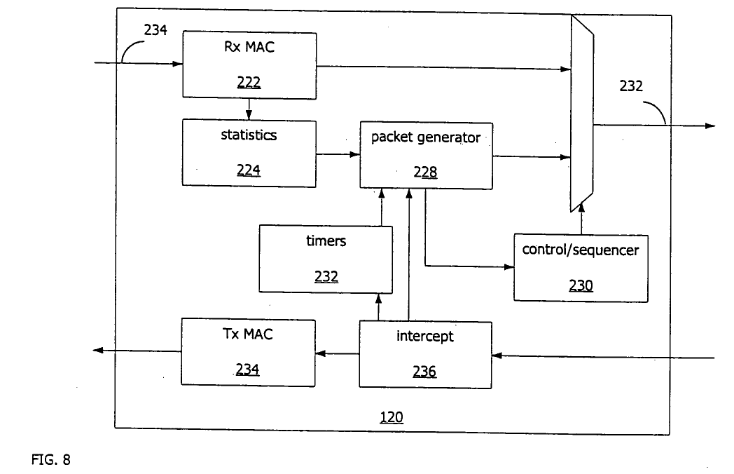

FIG. 8 depicts a sample implementation of an Ethernet MAC framer 120 in greater detail. As shown the framer 120 includes a Rx MAC 222 that operates on bits of a frame packet received via an interface 234 to a PHY (e.g., a Media Independent Interface). After framing operations performed by the Rx MAC 222, the framer 120 can output the resulting packet via an interface 232, such as a System Packet Interface (e.g. an SPI Level-n interface), to a component further along the receive path. The framer 120 also includes a Tx MAC 234 that provides framing operations in the packet transmit path.

As shown, the framer 120 includes circuitry 224 to collect (or otherwise access) statistics monitoring framer operation such as one or more RMON defined statistics. When initiated, packet generator circuitry 228 constructs a packet including one or more of the statistic values. For example, like the PHY circuitry, the generator 228 may access a packet template and modify the template packet. Alternatively the generator 228 may access a header template and construct a packet by appending a payload containing data such as network statistics as well as any other information needed to form a valid packet. The packet might also contain additional information such as a sequence number, port identification, and/or a timestamp. Also, like the PHY, the framer 120 includes control and sequencer circuitry 230 to inject the generated packets into the packet stream at an appropriate interval.

The framer 120 may be configured in a variety of ways. For example, the framer 120 can be configured to include different selected network statistic(s) in the generated packets. Further, the framer 120 can be configured to provide the current “free running” count of these statistics or a “delta” value that identifies the change in the value(s) since the last generated packet. Additionally, the framer 120 can be configured to permit the counters to free-run or to zero the counters after collecting statistics to include in the generated packet.

The framer 120 may be configured to generate different packets at different intervals or events which contain different selected sets of statistics. These different packets may be indicated with different packet header values and/or with different payload contents or flags.

Packet generation may be triggered by a variety of mechanisms. For example, the framer 120 may receive a request to generate a packet. As shown, the framer 120 can include one or more dump timers 232 that can be configured to initiate packet generation at regular intervals. Additionally, the framer 120 can be configured to initiate packet generation when some programmed threshold is reached (e.g., a number of errors). The framer 120 may include a plurality of thresholds associated with different statistics counters. The framer may further include a plurality of dump timers 232 associated with dumping packets containing a variety of statistics.

Configuration of the framer can be performed using a variety of mechanisms. For example, the framer 120 can include configuration registers. As an example, a processor can write data to the configuration registers to identify statistics of interest or to specify a desired packet generation interval. Alternately, as shown, the framer 120 can include intercept 238 circuitry that monitors packets traveling through the framer 120 down the transmit path for special “dump command” packets. These packets conform to the same protocol format as other packets in the transmit path packet stream, but, much like the packets generated by the framer 120, are constructed to have characteristics (e.g., header values) that identify themselves as packets terminally destined for a component in the transmit path (e.g., the framer 120) as opposed to packets destined for remote network destinations. The “dump command” packets can identify the statistic(s) to include in the packets generated by the framer 120 and/or the time(s) to generate such packets. Potentially, different configuration packets may request different sets of statistics at different intervals or upon the occurrence of different events. The framer 120 may also intercept “dump” packets identifying a “one time” request for packet generation. The “dump command” packets may further include identifying information which may be used by the framer 120 to tag or otherwise identify packets generated in response to a “dump command” packet.

A packet configuring the framer to generate a packet at a regular interval should indicate an interval value small enough to avoid multiple counter roll-overs. Briefly, a counter is much like a car-odometer. When a maximum counter value is reached, the counter resets (“rolls over”) to zero and continues. Thus, a packet should, generally, be generated in less that the roll-over period.

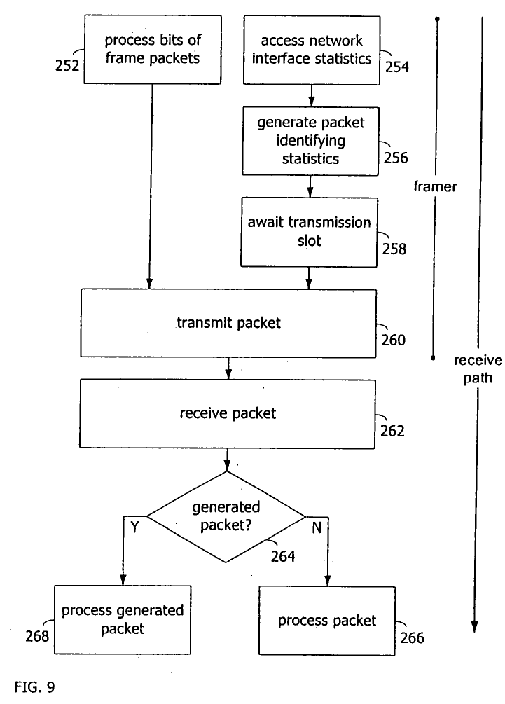

FIG. 9 illustrates operation of a framer. As shown, the framer processes 252 packets received from a PHY and transmits 260 the resulting packets further along the receive path. Simultaneously, at a specified interval or in response to a one-time request, the framer can access 254 network interface statistics, generate 256 a packet identifying one or more the statistic(s) values, and inject 258, 260 the generated packet into the receive path packet stream. Alternatively the framer 120 might access the network statistics 254 on a continuous basis and generate a packet when a specified counter reaches a specified threshold value.

A component further along the receive path can pick 264 the generated packets out of the packet stream. For example, a host processor can identify framer generated packets and access the packet contents to update the host's store of statistic values. For instance, the host can cache the statistic values or update a central store of the statistics.

The PHY, framer, and/or other components may be produced individually or packaged together in a variety of ways. For example, a network interface controller (NIC) may include a MAC framer implementing techniques described above, and might further include a PHY. Similarly, a PHY and/or framer implementing techniques described above may be included in a network interface card or a processor chipset or a network processor. The component(s) may also be included, for example, in a switch or router line card.

The preceding description used terminology consistent with the Open Source Institute (OSI) and Transmission Control Protocol/Internet Protocol (TCP/IP) protocol stacks. However, the techniques described above may also be used in conjunction with other network architectures (e.g., an Asynchronous Transfer Mode (ATM) protocol stack). The description frequently used the term packet as referring to a frame. However, the term packet also includes fragments, TCP segments, IP packets, ATM cells, and so forth.

The term circuitry as used herein includes hardwired circuitry, digital circuitry, analog circuitry, programmable circuitry (e.g., a processor), and so forth. The programmable circuitry may operate on computer programs. Such computer programs may be coded in a high level procedural or object oriented programming language. However, the program(s) can be implemented in micro-code, assembly, or machine language if desired. The language may be complied or interpreted. Additionally, these techniques may be used in a wide variety of networking environments.

Other embodiments are within the scope of the following claims.

1. A set of at least one component to handle packets, comprising:
a first component, comprising:
an input interface to receive data of packets;
an output interface;
circuitry to:
generate packets including a header and a payload such that data values within the generated packet payloads include data originating within the first component; and
transmit packets via the output interface to a component further along a receive path monotonically ascending layers of a protocol stack, the packets to transmit including the generated packets and packets including data of packets received via the input interface.

2. The set of at least one component to handle packets of claim 1,
wherein the first component comprises a PHY.

3. The set of at least one component to handle packets of claim 2,
wherein the input interface comprises signal to digital conversion circuitry,
the circuitry operating on at least one of the following: optic signals, wire signals, and wireless signals.

4. The set of at least one component to handle packets of claim 2,
wherein the output interface comprises a Media Independent Interface.

5. The set of at least one component to handle packets of claim 2,
wherein the data originating within the first component comprises at least one status of the PHY.

6. The set of at least one component to handle packets of claim 5,
wherein the at least one status comprises at least one of: link up and link down.

7. The set of at least one component to handle packets of claim 5, wherein the data originating within the first component further comprises at least one of a sequence number and a timestamp.

8. The set of at least one component to handle packets of claim 2,
wherein the PHY further comprises circuitry to determine when to transmit the generated packets.

9. The set of at least one component to handle packets of claim 2,
further comprising a second component, the second component to identify packets generated by the PHY.

10. The set of at least one component to handle packets of claim 9, wherein the second component comprises a component to intercept the packets generated by the PHY.

11. The set of at least one component to handle packets of claim 9,
wherein the second component comprises at least one of a framer, a device driver, and a processor.

12. The set of at least one component to handle packet of claim 2, wherein the PHY further comprises circuitry to intercept PHY configuration packets traveling along a transmit path monotonically descending the layers of the protocol stack.

13. The set of at least one component to handle packets of claim 1,
wherein the first component comprises a framer.

14. The set of at least one component to handle packets of claim 13,
wherein the input interface comprises an interface to a PHY.

15. The set of at least one component to handle packets of claim 13,
wherein the output interface comprises a System Packet Interface (SPI).

16. The set of at least one component to handle packets of claim 13,
wherein the data originating within the framer comprises at least one network interface statistic.

17. The set of at least one component to handle packets of claim 16,
wherein the at least one network interface statistic comprises at least one of: packets received, packets transmitted, bytes received, and bytes transmitted.

18. The set of at least one component to handle packets of claim 16, wherein the data originating within the framer further comprises at least one of a sequence number and a timestamp.

19. The set of at least one component to handle packets of claim 13,
wherein the framer further comprises circuitry to determine when to transmit the generated packets.

20. The set of at least one component to handle packets of claim 13,
further comprising a second component, the second component to identify packets generated by the framer.

21. The set of at least one component to handle packets of claim 20, wherein the second component comprises a component to intercept the packets generated by the PHY.

22. The set of at least one component to handle packets of claim 13,
wherein the framer comprises at least one of: an Ethernet media access controller (MAC), a High-Level Data Link (HDLC) framer, and a Synchronous Optical NETwork (SONET) framer.

23. The set of at least one component to handle packets of claim 13, wherein the framer further comprises:
a second input interface to receive packets along a transmit path;
a second output interface; and
circuitry to:
identify packets in the transmit path destined for the framer;
examine the contents of a packet destined for the framer, the contents identifying at least one of: at least one statistic to include in the generated packets, a request to generate at least one packet, at least one time to generate at least one of the generated packets; and
transmit packets not destined for the framer via the second output interface to a component further along a transmit path monotonically descending layers of a protocol stack.

24. The set of at least one component to handle packets of claim 1, wherein the first component comprises a component to:
configure packet generation based on configuration packets received by the first component; and
eliminate the configuration packets from their packet stream.

25. The set of at least one component to handle packets of claim 1,
wherein the circuitry to generate packets comprises circuitry to generate a packet header identifying generated packets to a component further along the receive path.

26. The set of at least one component to handle packets of claim 1,
wherein the set of at least one component comprises a PHY component and a framer component, and
wherein at least one of the PHY component and the framer component comprises the circuitry to generate packets in the receive path.

27. The set of at least one component to handle packets of claim 1, wherein the set comprises at least one component of a network interface controller (NIC).

28. A method, the method comprising:
generating, at a first component, a packet having a header and payload, the payload including data originating within the first component; and
transmitting the packet to a second component further along a receive path monotonically ascending layers of a protocol stack.
